(19) United States
(12) Patent Application Publication
(10) Pub. No.: US 2012/0177927 A1
(43) Pub. Date: Jul. 12, 2012

(54) METHOD FOR MAKING A MOLDED CARBON FIBER PREPREG AND MOLDED CARBON FIBER PREPREG OBTAINED THEREFROM

(75) Inventor: FENG-YAO CHENG, KAOHSIUNG CITY (TW)

(73) Assignee: XIANMING INVESTMENT CO., LTD., KAOHSIUNG CITY (TW)

(21) Appl. No.: 13/287,610

(22) Filed: Nov. 2, 2011

(30) Foreign Application Priority Data
Jan. 10, 2011 (TW) 100100807

(51) Int. Cl. B32B 5/02; B32B 9/04; B32B 27/04; B29C 45/14

(52) U.S. Cl. 428/408; 264/279

(57) ABSTRACT

A method for making a molded carbon fiber prepreg includes the steps of: (a) thermocompressing a pristine carbon fiber prepreg that includes a carbon fiber substrate and a matrix resin impregnated into the carbon fiber substrate, and a thermoplastic material at an elevated temperature such that the thermoplastic material and the matrix resin of the pristine carbon fiber prepreg are subjected to a crosslinking reaction so as to form a crosslinked thermoplastic layer on the pristine carbon fiber prepreg; and (b) injection molding a thermoplastic elastomer onto the crosslinked thermoplastic layer. A molded carbon fiber prepreg obtained from the aforesaid method is also provided.

### CROSS-REFERENCE TO RELATED APPLICATION

This application claims priority of Taiwanese application no. 100100807, filed on Jan. 10, 2011.

### BACKGROUND OF THE INVENTION

1. Field of the Invention

This invention relates to a method for making a molded carbon fiber prepreg and a molded carbon fiber prepreg obtained therefrom.

2. Description of the Related Art

Generally, a polymeric material is injection molded onto a semi-finished article made from a material other than the polymeric material (e.g., carbon fiber prepreg) so as to form a molded product, such as a screwdriver, safety scissors, and a portable electrical device. However, the connection between the polymeric material and the semi-finished article is weak, thereby resulting in separation of the polymeric material from the semi-finished article. To improve the connection therebetween, a surface of the semi-finished article to be in contact with the polymeric material is treated by abrading, sandblasting, etching and other methods to improve the roughness of the semi-finished article, thereby increasing the contact area between the semi-finished article and the polymeric material. Since the connection between the semi-finished article and the polymeric material relies upon a physical bonding, the connection therebetween is still insufficient.

### SUMMARY OF THE INVENTION

Therefore, the object of the present invention is to provide a method for making a molded carbon fiber prepreg that can overcome the aforesaid drawback of insufficient connection strength of the prior art.

According to one aspect of this invention, a method for making a molded carbon fiber prepreg comprises the steps of: (a) thermocompressing a pristine carbon fiber prepreg that includes a carbon fiber substrate and a matrix resin impregnated into the carbon fiber substrate, and a thermoplastic material at an elevated temperature such that the thermoplastic material and the matrix resin of the pristine carbon fiber prepreg are subjected to a crosslinking reaction so as to form a crosslinked thermoplastic layer on the pristine carbon fiber prepreg; and, (b) injection molding a thermoplastic elastomer onto the crosslinked thermoplastic layer.

According to another aspect of this invention, a molded carbon fiber prepreg is obtained from the aforesaid method.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 illustrates consecutive steps of the preferred embodiment of a method for making a molded carbon fiber prepreg of this invention; and

FIG. 2 is a schematic sectional view showing a molded carbon fiber prepreg produced by the method shown in FIG. 1.

### DETAILED DESCRIPTION OF THE PREFERRED EMBODIMENT

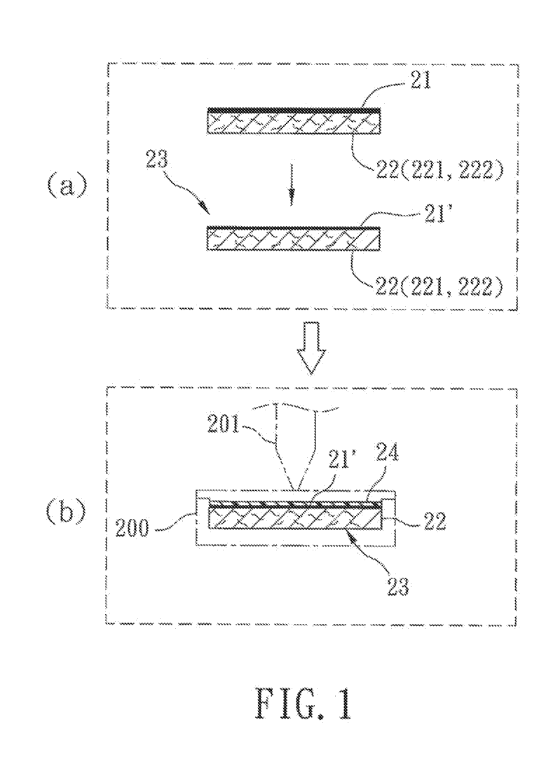

FIG. 1 shows the preferred embodiment of a method for making a molded carbon fiber prepreg according to the present invention. The method for making a molded carbon fiber prepreg comprises the steps of: (a) thermocompressing a pristine carbon fiber prepreg 22 that includes a carbon fiber substrate 221 and a matrix resin 222 impregnated into the carbon fiber substrate 221, and a thermoplastic material 21 at an elevated temperature such that the thermoplastic material 21 and the matrix resin 222 of the pristine carbon fiber prepreg 22 are subjected to a crosslinking reaction so as to form a crosslinked thermoplastic layer 21′ on the pristine carbon fiber prepreg 22; and (b) injection molding a thermoplastic elastomer 24 onto the crosslinked thermoplastic layer 21′.

In step (a), the elevated temperature is selected based on the species of the thermoplastic material 21 and is set to be below the melting point thereof. The thermoplastic material may be a thermoplastic olefinic (TPO) and will become soft and may be deformed at the elevated temperature. Examples of the thermoplastic material 21 include polyethylene terephthalate (PET) and thermoplastic polyurethane (TPU).

In this embodiment, the matrix resin 222 is an epoxy resin, and the thermoplastic material 22 is PET. The elevated temperature in step (a) ranges from 130° C. to 150° C.

When thermocompressing the thermoplastic material 21 and the pristine carbon fiber prepreg 22 at the elevated temperature, the matrix resin 222 becomes flowable and a part thereof flows to a surface of the pristine carbon fiber prepreg 22, and the matrix resin 222 on the surface of the pristine carbon fiber prepreg 22 and the thermoplastic material 21 are subjected to a crosslinking reaction so as to form the crosslinked thermoplastic layer 21′ on the pristine carbon fiber prepreg 22 to give a thermocompressed semi-finished product 23.

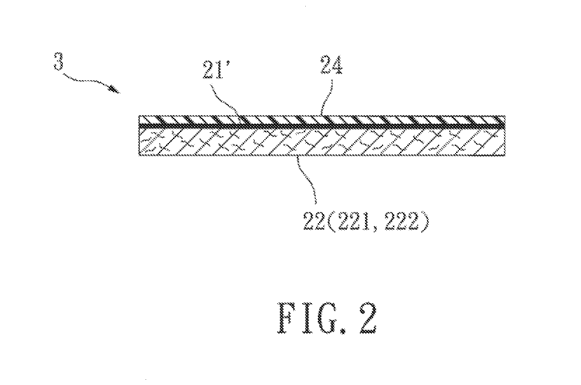

In step (b), the thermocompressed semi-finished product 23 is disposed into a mold 200. In this embodiment, the thermoplastic elastomer 24 is a thermoplastic olefinic elastomer, and is heated and melted at a temperature of 170° C., and is injection molded onto the thermocompressed semi-finished product 23 in the mold 200 through an injection molding machine 201. A molded carbon fiber prepreg 3 is thus obtained, as best shown in FIG. 2. Since the crosslinked thermoplastic layer 21′ and the thermoplastic elastomer 24 belong to a polymeric material, a chemical bonding is likely to be formed therebetween during injection molding.

It should be noted that, although the thermoplastic elastomer 24 is heated to 170° C., the high temperature will not cause the crosslinked thermoplastic layer 21′ to melt when the thermoplastic elastomer 24 is injected onto the thermocompressed semi-finished product 23, because the heat from the heated thermoplastic elastomer 24 is rapidly conducted to the mold 200.

By virtue of the crosslinking reaction carried out between the thermoplastic material 21 and the matrix resin 222 of the pristine carbon fiber prepreg 22 and the chemical bonding between the crosslinked thermoplastic layer 21′ and the thermoplastic elastomer 24, the disconnection problem associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A method for making a molded carbon fiber prepreg, comprising:
(a) thermocompressing a pristine carbon fiber prepreg that includes a carbon fiber substrate and a matrix resin impregnated into the carbon fiber substrate, and a thermoplastic material at an elevated temperature such that the thermoplastic material and the matrix resin of the pristine carbon fiber prepreg are subjected to a crosslinking reaction so as to form a crosslinked thermoplastic layer on the pristine carbon fiber prepreg; and
(b) injection molding a thermoplastic elastomer onto the crosslinked thermoplastic layer.

2. The method for making a molded carbon fiber prepreg as claimed in claim 1, wherein, in step (a), the thermoplastic material is selected from the group consisting of polyethylene terephthalate and thermoplastic polyurethane.

3. The method for making a molded carbon fiber prepreg as claimed in claim 2, wherein, in step (a), the matrix resin includes an epoxy resin, and the thermoplastic material is polyethylene terephthalate.

4. The method for making a molded carbon fiber prepreg as claimed in claim 3, wherein, in step (a), the elevated temperature ranges from 130° C. to 150° C.

5. The method for making a molded carbon fiber prepreg as claimed in claim 1, wherein, in step (b), the thermoplastic elastomer is a thermoplastic olefinic elastomer, and is melted at 170° C. and injection molded onto the crosslinked thermoplastic layer.

6. A molded carbon fiber prepreg obtained from the method as claimed in claim 1.
